(19) United States
(12) Patent Application Publication
(10) Pub. No.: US 2005/0029866 A1
(43) Pub. Date: Feb. 10, 2005

(54) Track adjuster

(75) Inventors: Masatake Tamaru, Osaka (JP); Teiji Yamamoto, Osaka (JP); Shigeru Yamamoto, Osaka (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/877,208

(22) Filed: Jun. 25, 2004

(30) Foreign Application Priority Data
Jun. 30, 2003 (JP) 2003-187687
Jun. 15, 2004 (JP) 2004-177116

(51) Int. Cl. F16H 7/12

(52) U.S. Cl. 305/125

(57) ABSTRACT

Right and left track adjusters each comprise a tension adjusting cylinder operable in forward and backward directions in the same condition; a motor-driven hydraulic pump; and a direction selector valve disposed in a hydraulic circuit for connecting the motor-driven hydraulic pump to the tension adjusting cylinder. The hydraulic circuit includes operating condition detecting means for detecting the operating condition of the tension adjusting cylinder. A controller located in the work vehicle judges a signal released from the operating condition detecting means. If the pressure condition is determined to be higher than a preset value, the tension adjusting cylinder is moved backward to avoid abnormal tension in the crawler belt. If it has a steady-state value, the movement of the tension adjusting cylinder is controlled according to a judgment based on a set value corresponding to the traveling direction of the vehicle, thereby properly adjusting the tension of the crawler belt.

### TECHNICAL FIELD

The present invention relates to a track adjuster for automatically adjusting the tension of a crawler belt of a track-type work machine such as a bulldozer during traveling.

### BACKGROUND ART

A known track-type work machine has crawler belts each of which is wrapped around its corresponding drive sprocket and idler. The drive sprocket is supported by a track frame as a base carrier and rotatively driven by a power from a drive source, and the idler is supported on the track frame so as to be movable in forward and backward directions. The crawler belts are each guidingly supported by track rollers at the ground engaging side and by track carrier rollers at the ground unengaging side. For creating and maintaining tension in the crawler belts, a track tensioner of the coil spring type or hydraulic cylinder type is interposed between each yoke for supporting a bearing for the idler and the track frame.

The crawler belts are constructed by coupling a plurality of track links by pins, and the track links, the coupling components (e.g., bushings and pins), the idlers, the teeth of the drive sprockets begin to wear over a period of time with the result that slack is caused in the wound crawler belts. If slack occurs in the crawler belts, irregular external force will affect the components of the crawler belts and the power transmission unit, giving damage to the crawler belts. Therefore, there arises a need to increase the tension of the crawler belts in order to eliminate slack in the crawler belts. As a means for increasing the tension of a crawler belt, there has been known a track tensioner provided with a cylinder filled with grease, according to which grease is manually injected into or discharged from the cylinder, thereby adjusting the tension of the crawler belt.

Such a track adjuster using grease as a medium is disclosed, for example, in Japanese Patent Kokai Publication No. 7-144668. Japanese Patent Kokai Publication No. 2000-247273 also discloses a track adjuster including a hydraulic cylinder (adjuster cylinder) for adjusting tension in a crawler belt provided on both sides of a work machine. In this publication, the track adjuster is provided on both sides and each includes a control circuit which is operated so as to properly absorb stroke fluctuations on both occasions when a load is imposed on both of the hydraulic cylinders and when a load is imposed on either of the hydraulic cylinders. Japanese Patent Kokai Publication No. 2001-206261 proposes a track adjuster for optimizing the tension of a crawler belt by a hydraulic cylinder.

The track adjuster disclosed in Japanese Patent Kokai Publication No. 7-144668 has, however, revealed the following problems.

(a) Since operating personal adjusts the tension of the crawler belts, using grease, it is practically impossible to change the tension of the crawler belts in every operation according to whether the work machine is in a forward drive state (during which the crawler belts may be relatively loosened) or a reverse drive state (during which the upper parts of the crawler belts should be tightly stretched). In addition, the use of this track adjuster causes a decrease in the efficiency associated with operation of the work machine.

(b) If a crawler belt bites foreign materials such as rocks during vehicle traveling or if earth and sand penetrate into and deposit on the tooth roots of a drive sprocket, causing abnormal tension in the crawler belt, the load on the coil spring increases, imposing a heavy load on every parts of the track frame. In view of this, the work machine needs a sturdy structure, which leads to an increase in vehicle weight and therefore additional cost.

(c) When the aforesaid rock-bitten state is cleared, the accumulated energy of the coil spring is released all at once. To withstand the impulsive load occurring at that time, the components of the crawler belts are required to have sufficient strength, which leads to an increase in the weight of the components. As a result, additional cost becomes inevitable.

Track adjusters utilizing a hydraulic cylinder such as disclosed in Japanese Patent Kokai Publication No. 2000-247273 are operated by an incompressible fluid unlike the spring type tensioners and therefore require an accumulator. For ensuring the reliability of the piping system for the accumulator, the accumulator needs to be periodically charged with gas and periodical piping (hydraulic hoses) replacement becomes necessary. In addition, this publication does not mention switching of optimum tensions during forward or reverse drive.

The track adjuster utilizing a hydraulic cylinder according to Japanese Patent Kokai Publication No. 2001-206261 is designed to have a positional sensor for use in control performed in synchronization with the expansion/contraction of the crawler belt. Such a control system is seemingly rational, however, imposes the following problem: Since work machines such as bulldozers are usually operated on the unleveled ground and therefore contaminated with earth and sand at their crawler travel units, the light beam of the sensor is likely to be cut off by earth and sand during operation. Therefore, such a sensor lacks accuracy. Even when a bobbin-shaped scale is used in addition to the laser as a means for measuring distance, if earth and sand penetrate into its measuring part during measurement (operation), the measuring function will be hampered, resulting in a failure in accomplishment of intended aims.

The invention is directed to overcoming the foregoing shortcomings and a primary object of the invention is therefore to provide a track adjuster for use in a track-type vehicle, the track adjuster being capable of automatically creating optimum tension in a crawler belt according to the traveling condition of the vehicle.

### SUMMARY OF THE INVENTION

The above object can be accomplished by a track adjuster according to the invention for use in a track-type vehicle which has right and left base carriers each having a drive sprocket and an idler for imparting tension to a crawler belt, the track adjuster comprising:
a hydraulic actuator disposed in the base carriers, for changing the position of the idler;
operating condition detecting means disposed in the base carriers, for detecting the operating condition of the hydraulic actuator;
control means for performing control in which the hydraulic actuator is operated according to a signal issued by the operating condition detecting means to move the idler to a position where it can create adequate tension in the crawler belt,
wherein the hydraulic actuator is driven by pressure oil discharged from a hydraulic pump,
wherein a direction selector valve is disposed in a hydraulic circuit for connecting the hydraulic pump to the hydraulic actuator,
wherein the operating condition detecting means is located in the hydraulic circuit, and
wherein the control means performs control, making a judgment based on a signal released from the operating condition detecting means, such that if the pressure of the hydraulic circuit is equal to or higher than a preset value, the hydraulic actuator is allowed to move backward to avoid generation of abnormal tension in the crawler belt and if the pressure of the hydraulic circuit has a steady-state value, the operation of the hydraulic actuator is controlled to make the tension of the crawler belt adequate.

According to the invention, in each of the track adjusters provided for the right and left base carriers, the hydraulic actuator for changing the position of the idler is operated by the control means according to a signal released from the operating condition detecting means, whereby the position of the idler is controlled to adjust tension in the crawler belt so that the tension of the crawler belt can be brought into an optimum condition according to the traveling condition of the vehicle. Accordingly, slack in the crawler belt caused by wear of the crawler belt components such as bushings and pins can be automatically eliminated thereby accomplishing tension optimization.

The right and left hydraulic actuators are activated and controlled by pressure oil fed from their respective independent hydraulic pumps. A signal generated by the operating condition detecting means for detecting the operating condition of its associated hydraulic actuator is judged by the control means and the position of the idler is changed by making the hydraulic actuator move forward or backward to adjust the tension of the crawler belt. With this arrangement, the crawler belts provided in the right and left base carriers can be respectively brought into an optimum condition according to the traveling condition of the vehicle. Accordingly, the condition of the crawler belts can be optimized, so that their life can be prolonged and the vehicle can travel smoothly.

### BRIEF DESCRIPTION OF THE DRAWINGS

FIG. 1 is a side view of a work machine equipped with track adjusters constructed according to a first embodiment of the invention.

FIG. 2 is a longitudinal sectional view of the track adjuster of the first embodiment.

FIG. 3 diagrammatically shows the track adjuster of the first embodiment and its control unit.

FIGS. 4(a), 4(b) graphically show the stroke of a tension adjusting cylinder vs. hydraulic pressure.

FIG. 5 is a flow chart of the operation of the track adjuster of the first embodiment.

FIG. 6 is a flow chart of a program in a shoe tension avoidance mode.

FIG. 7 is a flow chart of a program in an automatic tension adjustment mode.

FIG. 8 is a flow chart of a program in a turning-time pitch jump avoidance mode.

FIG. 9 is a table used for explanation of the turning-time pitch jump avoidance mode.

FIG. 10 is a schematic diagram of a track adjuster according a second embodiment.

### DETAILED DESCRIPTION OF THE INVENTION

Referring now to the accompanying drawings, a track adjuster will be concretely described according to preferred embodiments of the invention.

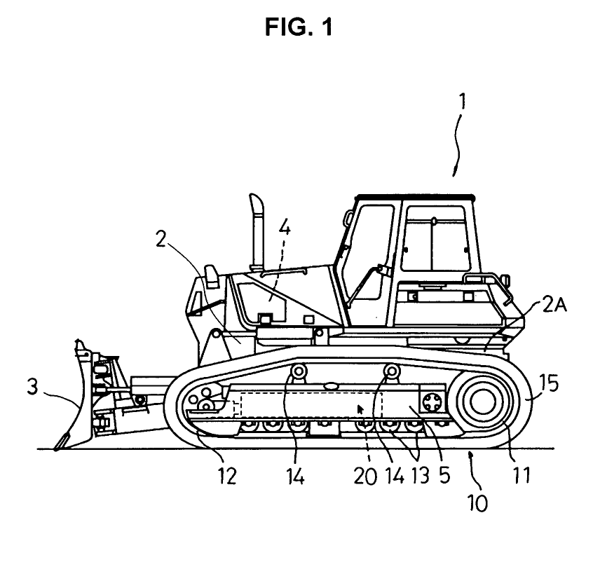

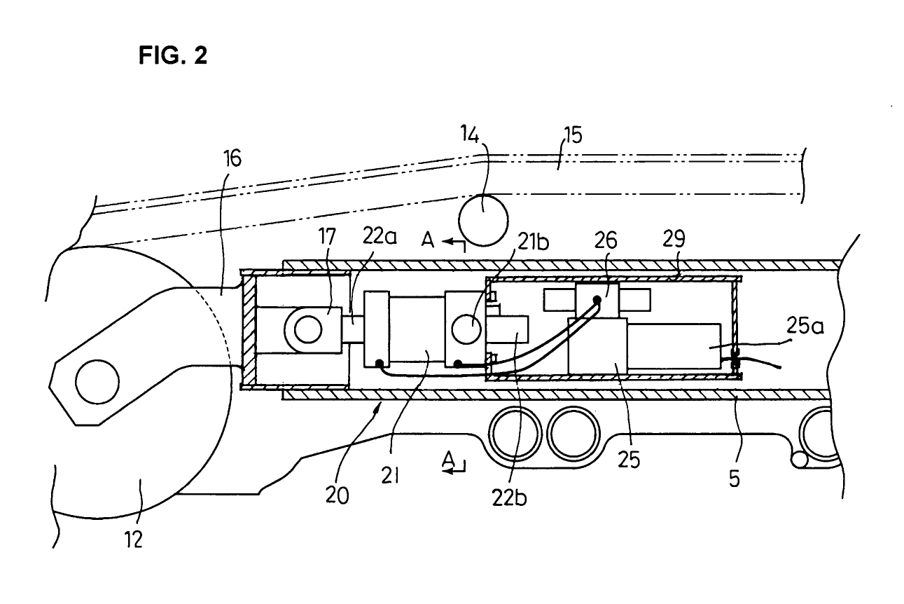

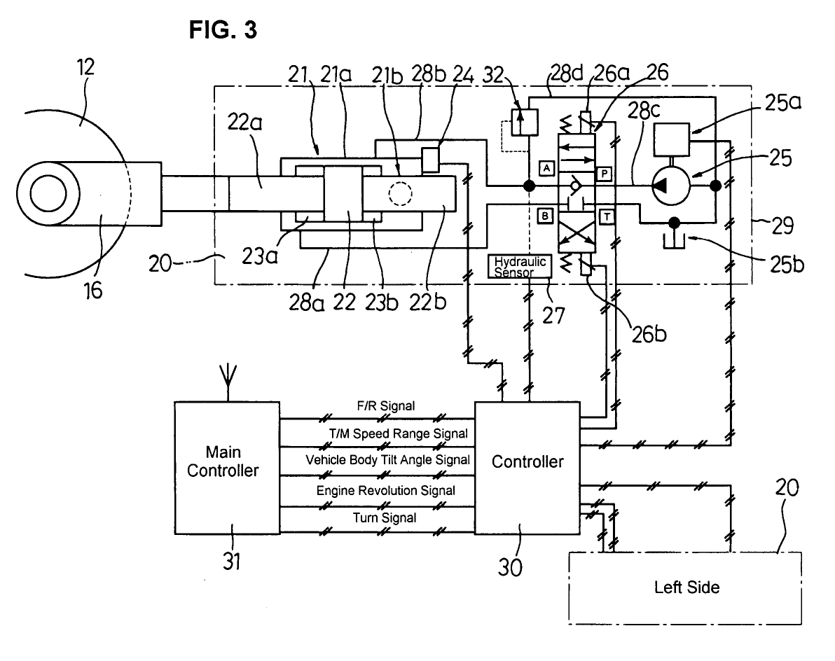

FIG. 1 is a side view of a work machine equipped with track adjusters constructed according to a first embodiment of the invention. FIG. 2 is a longitudinal sectional view of the track adjuster of the first embodiment. FIG. 3 diagrammatically shows the track adjuster of the first embodiment and its control unit.

The first embodiment is associated with a track adjuster which is applied to a bulldozer 1 shown in FIG. 1, the bulldozer 1 serving as a track-type work machine for use in operations such as earth moving and ripping. The bulldozer 1 includes work implements such as a blade 3 and a ripper (not shown) which are operated by a hydraulic drive. In the bulldozer 1, an engine 4 is mounted on a vehicle body 2, for activating the blade 3 and the ripper and making the vehicle move. This bulldozer 1 has a crawler travel unit (base carrier) 10 on both sides of a main frame 2A.

Each crawler travel unit 10 has (i) a drive sprocket 11 disposed at the rear end of a track frame 5 provided at both sides of the main frame 2A, (ii) an idler 12 located at the front end, (iii) a plurality of track rollers 13 disposed in the lower intermediate part of the track frame 5, (iv) a plurality of track carrier rollers 14 disposed in the upper intermediate part of the track frame 5, and (v) an endless crawler belt 15 wrapped around the drive sprocket 11 and the idler 12. The endless crawler belt 15 is held at the intermediate part thereof by the track rollers 13 and the track carrier rollers 14. The crawler belt 15 is constructed in an endless form by sequentially coupling a multiplicity of track links with coupling pins, each track link having a track shoe attached thereto. A driving force is transmitted from a hydraulic power unit (not shown) mounted on the vehicle body 2 to the drive sprocket 11 thereby making the vehicle move.

Each crawler travel unit 10 has a track adjuster 20 positioned relative to the idler 12 which is located in front of the track adjuster 20 provided on the right and left sides of the main frame 2A. The track adjuster 20 is for adjusting the tension of the crawler belt 15 so as to take up the slack of the crawler belt 15 caused by wear that occurs between the coupling pins and bushings for the track links and the teeth of the drive sprocket 11 during vehicle traveling and so as to prevent an increase in the load caused by rocks etc. bitten by the crawler track 15. As the right/left pair of crawler travel units 10 and the right/left pair of track adjusters 20 are both symmetrically formed, one of each pair will be described in terms of structure.

As shown in FIGS. 2 and 3, the track adjuster 20 is incorporated in the track frame 5 disposed at both sides of the main frame 2A of the bulldozer 1. The track adjuster 20 is designed to be operated, being directly coupled with the idler 12 that is movably supported at the front end of the track adjuster 20 (or being in contact with the idler 12 so as to enable power transmission). The track adjuster 20 is comprised of a tension adjusting cylinder (hydraulic actuator) 21, a hydraulic pump 25 driven by an electric motor 25a, an electromagnetic direction selector valve 26, a hydraulic sensor 27 and a hydraulic circuit which connect these parts in a closing manner. These members are housed in a tubular casing 29 as a unit. The track adjuster 20 is inserted into the tubular track frame 5 and the rod of the tension adjusting cylinder 21 is connected to the rear end of a yoke 16 for supporting the idler 12 to operate the yoke 16.

The tension adjusting cylinder 21 is formed such that a piston rod front end portion 22a and a piston rod rear end portion 22b project from a cylinder head with respect to a piston 22 that is slidable in pressure chambers formed in a cylinder body 21a. Front and rear pressure chambers 23a, 23b partitioned by the piston 22 are formed such that the pressure chamber 23a is equal to the pressure chamber 23b in terms of pressure acting on the piston 22. The piston rod front end portion 22a is connected by a joint 17 to the axial end of the yoke 16 for slidably supporting the idler 12. A cylinder stroke sensor 24 for a piston rod rear end portion 22b is attached to the rear cylinder head to measure the movement of the piston rod rear end portion 22b. A movement signal (positional signal) indicative of the movement of the piston rod rear end portion 22b is sent to a controller (control means) 30 disposed in place in the main frame 2A. The cylinder stroke sensor 24 is used for not only setting tension at the initial winding stage of the crawler belt but also detecting changes in the condition of the crawler belt in use from the aforesaid movement. The tension adjusting cylinder 21 is supported by a trunnion 21b and immediately acts in response to the displacement of the idler 12 in an upward or downward direction.

The hydraulic pump 25 is directly connected to the electric motor 25a and constructed in the form of a pump unit to which a small-sized operating oil tank 25b is integrally attached. Pipe lines 28a, 28b are connected to the front pressure chamber 23a and rear pressure chamber 23b, respectively, of the tension adjusting cylinder 21. The pipe lines 28a, 28b are also connected to the discharge opening of the hydraulic pump 25 by a pipe line 28c. In the middle of the pipe line 28c, a three position-four port type electromagnetic direction selector valve (hereinafter referred to as “a direction selector valve”) 26 is provided. In the middle of the pipe line 28b which connects the direction selector valve 26 to the rear pressure chamber 23b of the tension adjusting cylinder 21, the hydraulic sensor (operating condition detecting means) 27 is disposed. The pipe line 28b, which connects the outlet side of the hydraulic pump 25 to the rear pressure chamber 23b of the tension adjusting cylinder 21, is provided with a bypass 28d which is, in turn, connected to the suction side (the operating oil tank 25b side) of the hydraulic pump 25. Inserted into the bypass 28d is a relief valve 32 for pushing the pressure oil back to the suction side in the event of an abnormal rise in pressure.

The front and rear pressure chambers 23a, 23b of the tension adjusting cylinder 21 are connected to the hydraulic pump 25 and the operating oil tank 25b by the closed hydraulic circuit and designed to function as an independent hydraulic actuator. These parts are formed as a unit. The parts except the tension adjusting cylinder 21 are housed in the casing 29 connected to the tension adjusting cylinder 21. The casing 29 is designed to be inserted into the tubular track frame 5. Since the track adjuster 20 has such a structure, it can be independently hydraulically driven without being connected to the hydraulic drive source located in the vehicle body. The trunnion 21b of the tension adjusting cylinder 21 is supported by a support bearing (not shown) disposed in the track frame 5.

As diagrammatically shown in FIG. 3, the track adjuster 20 having a unit construction is formed such that detection signal generators such as the hydraulic sensor 27 and the cylinder stroke sensor 24 are electrically connected to the controller for tension adjustment 30 which adjoins a main controller 31 disposed in place in the vehicle body. A means for transmitting a command signal to the electric motor 25a for the hydraulic pump 25 and to the solenoids 26a, 26b of the direction selector valve 26 is connected to the controller 30. In the operation unit of the controller 30, data on the tilt angle of the vehicle body etc. is received from the main controller 31 and then compared with previously input data to release a command signal to the specified members according to the situation. Accordingly, what should be connected to the track adjuster 20 from the vehicle body side is only control signal lines connected to the parts (the direction selector valve 26, the hydraulic sensor 27 and the cylinder stroke sensor 24) and a power line connected to the electric motor 25a. Thus, the small-sized track adjuster 20 can be realized.

In the track adjuster 20 of the first embodiment having such a structure, pressure oil is supplied through the direction selector valve 26 which has been switched to activate the hydraulic pump 25 so as to interconnect the pipe line 28c and the pipe line 28b which is normally connected to the rear pressure chamber 23b of the tension adjusting cylinder 21, whereby the piston 22 of the tension adjusting cylinder 21 moves forward. The piston rod front end 22a pushes the support yoke 16 to move the idler 12 forward, thereby imparting desired tension to the crawler belt 15 wound around the idler 12.

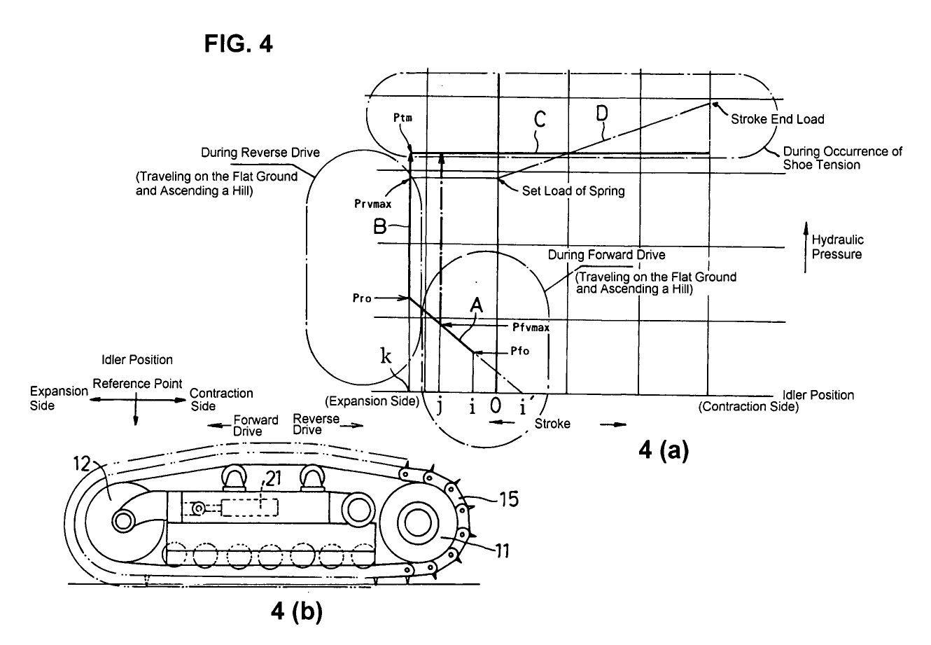

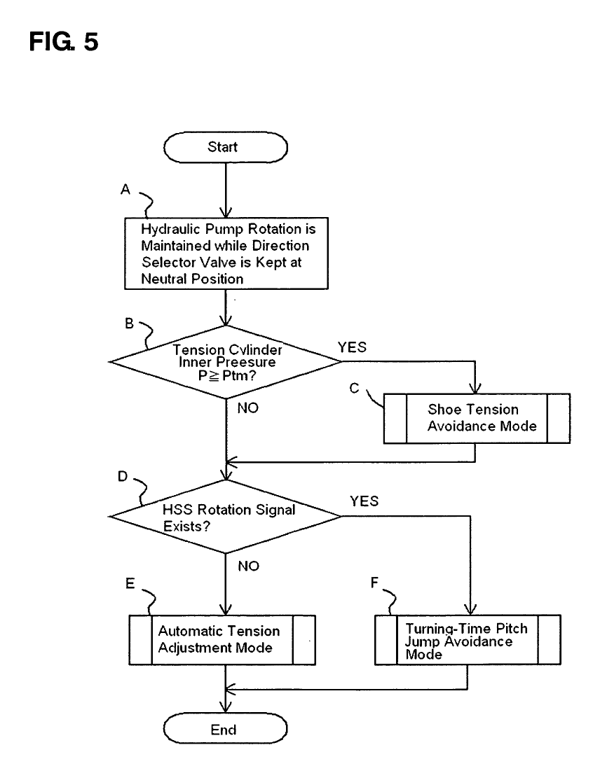

Next, the operation of the track adjuster 20 of the first embodiment will be described with reference to the tension adjusting cylinder stroke vs. hydraulic pressure graph shown in FIG. 4 and the flow charts of FIGS. 5 to 7.

First of all, reference is made to the tension adjusting cylinder stroke vs. hydraulic pressure graph of FIG. 4 for explaining the function of the tension adjusting cylinder 21 of the track adjuster 20.

In the track adjuster 20, when the idler 12 is positioned at the winding position i′, the crawler belt 15 is wrapped around the drive sprocket 11 and the idler 12. Thereafter, pressure is applied to the rear pressure chamber 23b of the tension adjusting cylinder 21 such that pressure P in the rear pressure chamber 23b of the tension adjusting cylinder 21 becomes equal to a preset value of slack. If this pressure P is set to a hold pressure value Pfo for forward drive on the flat ground (hereinafter referred to as “flat-ground forward-drive hold pressure value Pfo”), the idler 12 will move to a preset idler forward movement position i, after passing through a reference position 0.

When the vehicle is in its reverse drive state, the weight of the vehicle works on the ground engaging side of the crawler belt 15 so that the crawler belt 15 is pressed against the ground. Therefore, if an upper portion of the crawler belt 15 is loose when pulled toward the side of the drive sprocket 11 by rotation of the drive sprocket 11, slack is likely to occur in the engagement between the crawler belt 15 and the drive sprocket 11, at the side to which the crawler belt 15 is paid out by the drive sprocket 11. As a result, there arises a possibility that the so-called pitch jump (the phenomenon in which the crawler belt 15 disengages from the drive sprocket 11 at a paying-out position) may occur. To prevent this, the movement of the vehicle is switched to reverse drive and at the same time, the pressure P is increased to a hold pressure value Pro for reverse drive on the flat ground (hereinafter referred to as “flat-ground reverse-drive hold pressure value Pro”). This causes the tension adjusting cylinder 21 to be operated to move the idler 12 to an idler advancement position k for reverse drive. As a result, the upper portion of the crawler belt 15 becomes tensioned.

When the vehicle is ascending a hill during reverse drive, the load imposed on the crawler belt 15 by the tractive force created at that time increases. Therefore, the vehicle travels with the tension adjusting cylinder 21 being kept at the idler advancement position k for reverse drive as described earlier. As the tilt angle of the vehicle during ascending increases, the hold pressure of the tension adjusting cylinder 21 increases. Pressure is increased until it reaches the maximum ascending reverse drive hold pressure Prvmax (as indicated by B in FIG. 4), whereby the vehicle can travel with the crawler belts 15 being not slackened but kept in a tightened condition, so that the tractive force can be maintained. When the inner pressure of the rear pressure chamber 23b has reached the maximum ascending reverse drive hold pressure Prvmax, the tension adjusting cylinder 21 expands to substantially the same degree as in the case where a spring-set load is applied in the conventional spring-type tack tensioner.

If the vehicle descends a hill while restraining vehicle speed (i.e., actuating the engine brake) during forward drive, the tension adjusting cylinder 21 imparts adequate tension to the crawler belt 15 in response to a vehicle body tilt angle signal similarly to the case of reverse drive. Descending during reverse drive does not need track tension such as required for ascending, and adequate tension can be given to the crawler belt 15 by switching the operation of the tension adjusting cylinder 21 in response to a vehicle body tilt angle signal similarly to the case of forward drive on the flat ground.

If shoe tension occurs owing to rocks or the like bitten by the crawler belt 15, excessive tension is generated in the crawler belt 15 with the position of the idler 12 unchanged, irrespective of whether the vehicle is in the forward drive or reverse drive state, so that the inner pressure (the pressure P of the rear pressure chamber 23b) of the tension adjusting cylinder 21 rapidly rises. When the inner pressure has reached a specified pressure value Ptm (=1.1×Prv), the pressure condition C is kept as it is and the rod of the tension adjusting cylinder 21 is withdrawn to move the idler 12 backward thereby mitigating the tension working on the crawler belt 15. When the bitten rocks or the like get out of the crawler belt 15, the tension of the crawler belt is eliminated so that the pressure immediately returns to the flat-ground forward-drive hold pressure Pfo or the flat-ground reverse-drive hold pressure Pro. As a result, tension adequate for forward drive or reverse drive is created in the crawler belt 15. This operation is automatically carried out based on data comparison operation that is performed by the controller 30 and the main controller 31 (see FIG. 3) in response to a signal input to the controller 30 from the hydraulic sensor 27.

Code D in FIG. 4 indicates a line representative of a load characteristic obtained when shoe tension occurs in the existing spring-type track adjuster. In the spring-type track adjuster, a spring to which loads ranging from the spring set load (286 kN) to the stroke end load (380 kN) are applied is mounted through a grease cylinder.

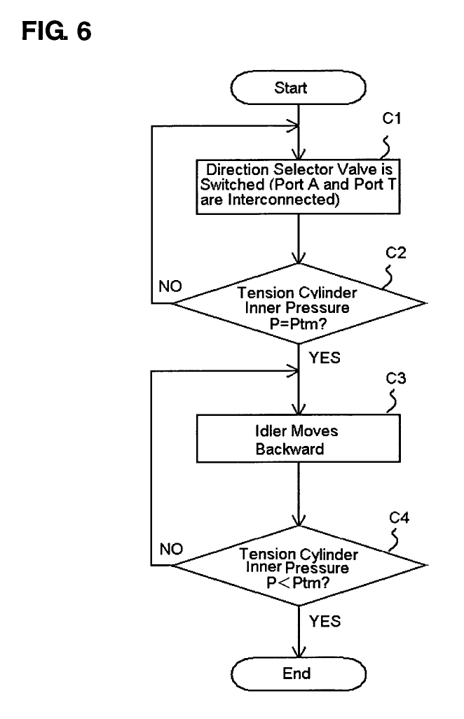

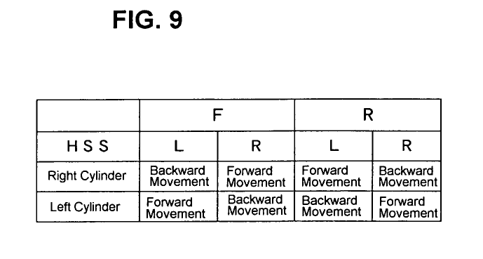

Reference is now made to the flow charts of FIGS. 5 to 8 and the table of FIG. 9 for more concretely describing the operation of the track adjuster 20 of the first embodiment. FIG. 5 is a flow chart of the entire operation of the track adjuster of the first embodiment. FIGS. 6 to 8 are flow charts of a shoe tension avoidance mode, an automatic tension adjustment mode and a turning-time pitch jump avoidance mode, respectively.

Step A: When the track adjuster normally starts up, the direction selector valve 26 is kept in its neutral position. If the discharge pressure of the electric hydraulic pump 25 falls in a preset range, the rotational speed of the electric hydraulic pump 25 will drop, and whenever the need arises, the electric hydraulic pump 25 is rotated so as to replenish the valves etc. with oil the amount of which corresponds to leakage. Therefore, the piston 22 of the tension adjusting cylinder 21 (hereinafter referred to as “tension cylinder 21” in the following description of the flow charts) is kept in a steady-state position so as to have a preset value.

Steps B to C: The hydraulic pressure P (hereinafter referred to as “tension cylinder inner pressure”) in the rear pressure chamber 23b of the tension cylinder 21 is detected by the hydraulic sensor 27 disposed in the pipe line 28b and a detection signal issued by the sensor 27 is transmitted to the controller 30. In the operation unit of the controller 30, the data of the detection signal is compared to preset data. If the pressure P is equal to or higher than the preset value Ptm (P≧Ptm), the program proceeds to the shoe tension avoidance mode (Step C).

Steps D to F: If it is judged in Step B that the hydraulic pressure detected by the hydraulic sensor 27 is lower than the preset value (P<Ptm), a check is then made based on a signal from the main controller 31 to determine whether there exists a signal released from a system (HSS (Hydrostatic Steering System) motor) for making a difference in speed between the right and left drive sprockets of the vehicle. If an HSS rotation signal is absent, the program proceeds to the automatic tension adjustment mode (Step E). If an HSS rotation signal is present, the program proceeds to the turning-time pitch jump avoidance mode (Step F).

Next, the shoe tension avoidance mode (Step C of FIG. 5) will be described in more detail with reference to the flow chart of FIG. 6.

Step C1: It has been determined that the inner pressure of the tension cylinder P satisfies P≧=Ptm, and therefore electric current is applied to the solenoid 26b of the direction selector valve 26 to switch it so as to make the port A communicate with the port T. Then, pressure oil is sent to the front pressure chamber 23a of the tension cylinder 21 while the pressure oil within the rear pressure chamber 23b is put back to the operating oil tank 25b.

Steps C2 to C3: With the inner pressure of the tension cylinder 21 being substantially maintained at Ptm by switching the direction selector valve 26, the piston rod 22a of the tension cylinder 21 is moved to its contraction side, thereby moving the idler 12 backward. By the backward movement of the piston rod 22a (see “the pressure condition C when shoe tension occurs” shown in FIG. 4), stones or the like bitten by the crawler belt 15 can be removed without enhancing the function of the idler 12 for tensioning the crawler belt 15. If it is determined in Step C2 that the inner pressure P>Ptm, the program returns to Step C1.

Step C4: After rocks or the like bitten by the crawler belt 15 have been removed, the inner pressure P of the tension cylinder 21 becomes lower than Ptm (P<Ptm). As a result, the track adjuster is released from the shoe tension avoidance mode.

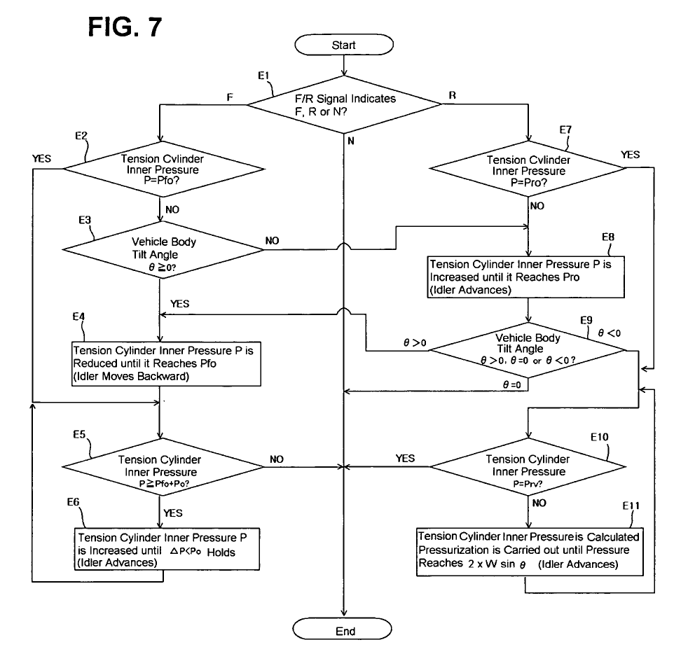

Next, referring to the flow chart of FIG. 7, the automatic tension adjustment mode (Step E of FIG. 5) will be described in more detail.

Step E1: If the motor electric current Im=0 and the switching electric current Iv of the direction selector valve 26=0, a check is then made based on an input signal from the main controller 31 to determine which of the forward drive, reverse drive and neutral states the vehicle is in. If it is determined the vehicle is in the forward drive (F) state, the program proceeds to Step E2. If it is determined that the vehicle is in the reverse drive (R) state, the program proceeds to Step E7. If it is determined that the vehicle is in the neutral (N) state, the flow of the automatic tension adjustment mode is ended.

Steps E2 to E4: A check is made to determine whether or not the inner pressure P of the tension cylinder 21 is equal to Pfo. If P≠Pfo, the program proceeds to Step E3. On the other hand, if P=Pfo, the program proceeds to Step E5. In Step E3, it is determined based on a vehicle body tilt angle signal sent from the main controller 31 whether the vehicle body is in a forward tilting condition or backward tilting condition. If it is determined that the vehicle is any of other conditions (tilt angle θ=0: (traveling on the flat ground) or tilt angle θ>0: (ascending a hill)) than the forward tilting condition, the program proceeds to Step E4. On the other hand, if it is determined that the vehicle is in the forward tilting condition (tilt angle θ<0: (descending a hill)), the program proceeds to Step E8. In Step E4 (where the vehicle is traveling on the flat ground or ascending a hill), an electric current is applied to the solenoid 26a of the direction selector valve 26 to connect the port A to the port T and connect the port B to the port P. At the same time, the motor 25a for the hydraulic pump 25 is rotated at high speed to supply pressure oil to the front pressure chamber 23a of the tension cylinder 21, so that the inner pressure of the rear pressure chamber 23b of the tension cylinder 21 is reduced to Pfo (see FIG. 4) thereby moving the idler 12 backward.

Steps E5 to E6: If the inner pressure of the tension cylinder 21 varies in conjunction with the vehicle speed and the margin of fluctuation ΔP increases, the crawler belt 15 is considered to be rattling. Therefore, an electric current is applied to the solenoid 26b of the direction selector valve 26 to connect the port A to the port P and at the same time, the motor 25a for the hydraulic pump 25 is rotated at high speed to supply pressure oil to the rear pressure chamber 23b of the tension cylinder 21 thereby raising pressure to an appropriate slack point and moving the piston 22 forward to move the idler 12 in a crawler belt tightening direction. The track adjuster is thus operated until the inner pressure fluctuation of the tension cylinder 21 stops, thereby ceasing the rattling of the crawler belt 15. If it is judged in Step E5 that the inner pressure fluctuation in the tension cylinder 21 stops, that is, P<Pfo+Po holds where Po is the threshold of the fluctuation margin ΔP from which the inner pressure fluctuation stops, the track adjuster is released from the automatic tension adjustment mode and then starts steady-state operation.

Steps E7 to E8: If it is determined in Step E1 that a signal indicative of the reverse drive (R) state has been received from the main controller 31, a check is then made to determine whether or not the inner pressure P of the tension cylinder 21 has a steady-state value. If it is determined in this judgment that the inner pressure P of the tension cylinder 21 is not equal to Pro (P≠Pro), the program proceeds to Step E8 in which an electric current will be applied to the solenoid 26b of the direction selector valve 26 to connect the port A to the port P. At the same time, the motor 25a for the hydraulic pump 25 is allowed to rotate at high speed to supply pressure oil to the rear pressure chamber 23b of the tension cylinder 21, thereby raising pressure, so that the piston 22 advances to the appropriate slack point to move the idler 12 in a track belt tightening direction. If it is determined in Step E7 that P=Pro, the program proceeds to Step E10.

Step E9: If it is determined based on a vehicle body tilt angle signal from the main controller 31 that the tilt angle θ of the vehicle body is zero (θ=0: the state in which the vehicle is traveling on the flat ground), the track adjuster is released from the automatic tension adjustment mode and then starts steady-state operation. If the tilt angle θ of the vehicle body is larger than zero (θ>0: ascending a hill), the program proceeds to Step E4 and the above-described backward movement of the idler 12 is carried out. On the other hand, if the tilt angle θ of the vehicle body is smaller than zero (θ<0: descending a hill), the program proceeds to Step E10.

E10: The inner pressure P of the tension cylinder 21 is calculated in the controller 30. If it is determined that P=Prv, the track adjuster is released from the automatic tension adjustment mode and then starts steady-state operation. If it is determined that P≠Prv (steady-state value), the program proceeds to Step E11 to calculate Prv in the controller 30. Then, the controller 30 sends a command signal to the direction selector valve 26 to energize its solenoid 26a, while rotating the motor 25a for the hydraulic pump 25 at high speed to supply pressure oil to the rear pressure chamber 23b of the tension cylinder 21, thereby pressurizing until the inner pressure P reaches 2×W sin θ (W: the weight of the vehicle body). In this way, the piston 22 advances to apply tension to the crawler belt through the idler 12. Thereafter, the inner pressure P of the tension cylinder 21 becomes equal to Prv (P=Prv) and this condition is maintained so that the track adjuster is released from the automatic tension adjustment mode and starts steady-state operation.

Thanks to the employment of such an automatic tension adjustment mode, when the vehicle is in the forward drive state, the vehicle can travel while avoiding creation of tension that causes excessive load in view of the traveling speed of the vehicle. If the vehicle body tilts (ascending a hill) during reverse drive, the operation, in which tension is created to take up slack in the drive sprocket 11 side thereby preventing rattling of the crawler belt 15 during vehicle traveling, is automatically carried out while detecting the pressure of the rear pressure chamber 23b of the tension cylinder 21. As a result, damage to the crawler belt 15 can be minimized and the durability of the crawler belt 15 can be increased to enable long use.

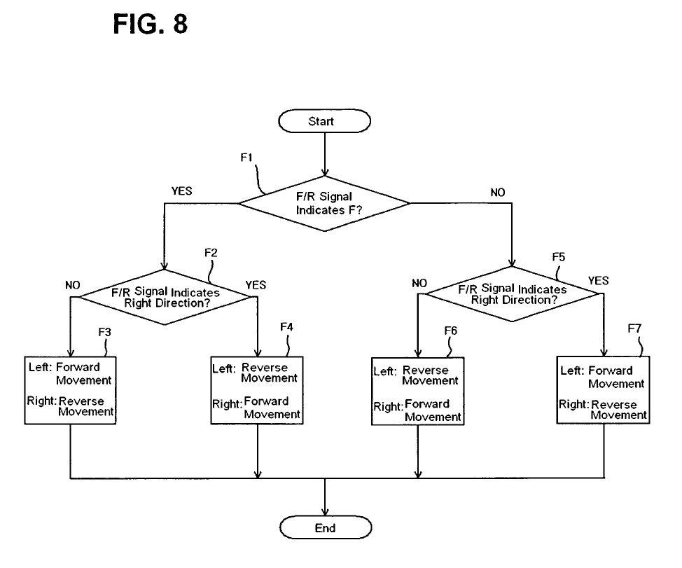

Reference is now made to the flow chart of FIG. 8 and the table of FIG. 9 to describe the turning-time pitch jump avoidance mode (Step F of FIG. 5) in more detail. In the turning operation, the crawler travel unit 20 of the right base carrier of the vehicle and the crawler travel unit 20 of the left base carrier are independently operated, and therefore the track adjusters (tension cylinders 21) incorporated therein are also independently controlled and operated.

Step F1: Based on a F/R signal from the main controller 31, it is determined in the controller 30 whether the vehicle is in the forward drive state (F) or the reverse drive state (R). If the vehicle is in the forward drive state (F), the program proceeds to Step F2. On the other hand, if the vehicle is in the reverse drive state (R), the program proceeds to Step F5.

Steps F2 to F4: If the vehicle is in the forward drive state (F), a check is then made to determine whether a right turn or left turn is being made (Step F2). If it is determined that the vehicle is turning to the left, the tension adjusting cylinder (left cylinder) of the left track adjuster is then moved forward while moving the tension adjusting cylinder (right cylinder) of the right track adjuster backward (Step F3). If the vehicle is turning to the right, the tension adjusting cylinder (left cylinder) of the left track adjuster is moved backward while moving the tension adjusting cylinder (right cylinder) of the right track adjuster forward (Step F4).

Steps F5 to F6: If the vehicle is in the reverse state (R), a check is similarly made to determine whether a right turn or left turn is being made (Step F5). If it is determined that the vehicle is turning to the left, the tension adjusting cylinder (left cylinder) of the left track adjuster is then moved backward while moving the tension adjusting cylinder (right cylinder) of the right track adjuster forward (Step F6). If the vehicle is turning to the right, the tension adjusting cylinder (left cylinder) of the left track adjuster is moved forward while moving the tension adjusting cylinder (right cylinder) of the right track adjuster backward (Step F7).

In the case of pivot turn, running of the right and left crawler travel units is controlled similarly to the case of turning described earlier.

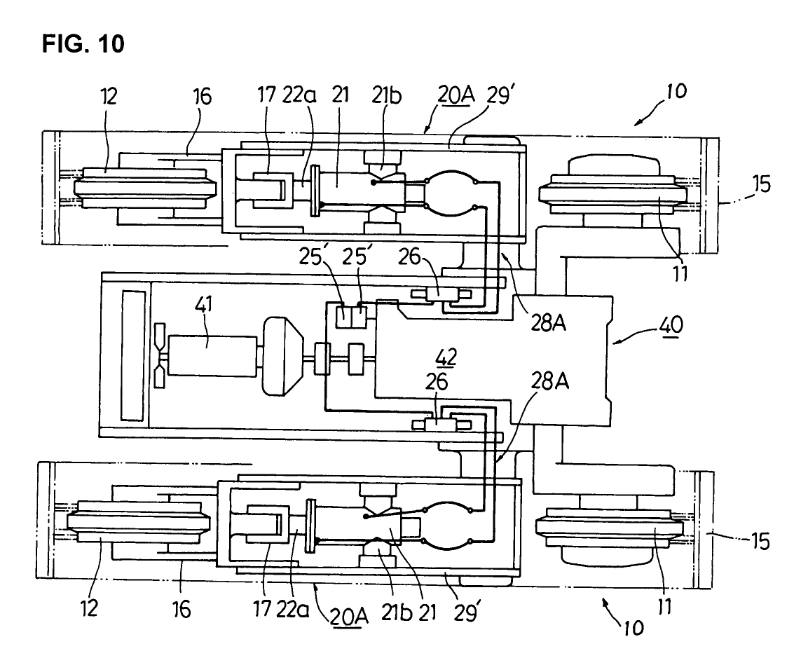

FIG. 10 schematically illustrates a track adjuster according to a second embodiment. The second embodiment is basically the same as the track adjuster of the first embodiment except the system for supplying pressure oil to the tension adjusting cylinder. Therefore, in the second embodiment, those parts that are substantially equivalent or function substantially similarly to those of the first embodiment are designated by the same reference numeral as in the first embodiment and a detailed explanation of them will be skipped.

According to the second embodiment, the right and left base carriers 10 are provided with track adjusters 20A respectively like the first embodiment, the track adjusters 20A having the same structure and being symmetrically arranged. The tension adjusting cylinder 21 for moving the idler 12 is incorporated in a tubular casing 29′ inserted into the track frame (not shown) of the base carrier and supported in the casing 29′ by the trunnion 21b. The idler 12 is connected to the yoke 16 for supporting the idler 12 by the piston rod 22a of the tension adjusting cylinder 21 and the joint 17, such that tension can be adjusted. In this embodiment, the rear part of the yoke 16 is fitted in and slidably supported by the casing 29′.

In the hydraulic circuit for the tension adjusting cylinder 21 designed as described above, part of power transmitted to a transmission 42 from an engine 41 of a power driving unit 40 disposed in the vehicle body is taken out. Independent hydraulic pumps 25′ respectively provided for the right and left tension adjusting cylinders 21 are mounted on the vehicle body. The hydraulic pumps 25′ are connected to hydraulic piping (collectively indicated by reference numeral 28A) through the direction selector valve 26 mounted on the vehicle body.

In the second embodiment having the above structure, control is performed according to the above-described flow charts. Thus, the track adjuster 20A of the second embodiment has the same effect as in the first embodiment, even though the hydraulic pump 25′ and the direction selector valve 26 are disposed in the vehicle body 2 and the hydraulic pump 25′ directly driven by the engine 41 is employed instead of the electric-motor-driven pump used in the first embodiment. In the second embodiment, although the hydraulic piping and electric wires for control are required to be connected to the vehicle body and the tension adjusting cylinders 21 of the base carriers 10, there is the advantage that the structure of the parts where the tension adjusting cylinders 21 are installed can be simplified.

In the track adjuster of the invention, operations such as automatic tension adjustment and shoe tension avoidance can be automatically controlled by detecting the pressure condition of the rear pressure chamber of the crawler belt tension adjusting cylinder and comparing the detected value with preset data in the controller. As a result, it becomes unnecessary to adjust the tension of the crawler belts prior to a start of operation and the adjustment can be thus rationally done so that wear of the crawler belts can be minimized for enabling long use and more improved economical efficiency can be achieved.

Data on the tension of the crawler belts as well as data on stretching of crawler belt pitch which are read out of a positional signal from the stroke sensor 24 are accumulated in the main controller 31 and then transmitted to a control center located at a remote base place, utilizing, for instance, a satellite communication facility. With this arrangement, the condition of the undercarriage of the work machine in operation can be kept under control.

Whereas the above discussion has been presented in terms of a track adjuster for a crawler belt used in the undercarriage of a work machine such as a bulldozer, it is obvious that the present invention provides track adjusters applicable to other work machines.

1. A track adjuster for use in a track-type vehicle which has right and left base carriers each having a drive sprocket and an idler for imparting tension to a crawler belt, the track adjuster comprising:
a hydraulic actuator disposed in the base carriers, for changing the position of the idler;
operating condition detecting means disposed in the base carriers, for detecting the operating condition of the hydraulic actuator; and
control means for performing control in which the hydraulic actuator is operated according to a signal issued by the operating condition detecting means to move the idler to a position where it can create adequate tension in the crawler belt,
wherein the hydraulic actuator is driven by pressure oil discharged from a hydraulic pump,
wherein a direction selector valve is disposed in a hydraulic circuit for connecting the hydraulic pump to the hydraulic actuator,
wherein the operating condition detecting means is located in the hydraulic circuit, and
wherein the control means performs control, making a judgment based on a signal released from the operating condition detecting means, such that if the pressure of the hydraulic circuit is equal to or higher than a preset value, the hydraulic actuator is allowed to move backward to avoid generation of abnormal tension in the crawler belt and if the pressure of the hydraulic circuit has a steady-state value, the operation of the hydraulic actuator is controlled to make the tension of the crawler belt adequate.

2. The track adjuster according to claim 1, wherein even if it is determined from a signal from the operating condition detecting means that the pressure of the hydraulic circuit is higher than the preset value, the control means performs control such that when the hydraulic actuator is operated by the direction selector valve to move to a loose side, the hydraulic actuator is actuated in a loosening direction while the tension of the crawler belt being maintained.

3. The track adjuster according to claim 1, wherein the control means performs control such that if it is determined from a signal from the operating condition detecting means that the pressure of the hydraulic circuit is equal to or lower than an abnormal value, an automatic tension adjustment mode is selected and the working pressure of the hydraulic actuator is adjusted so as to take up the slack of the crawler belt at the loose side if the pressure of the hydraulic circuit exceeds a pressure fluctuation value caused by rattling of the crawler belt when the vehicle is in a forward drive state or reverse drive state.

4. The track adjuster according to claim 1, wherein the control means performs control such that a setting range of detection signals to be issued by the operating condition detecting means is varied depending on a vehicle traveling direction signal, vehicle body tilt angle signal and traveling speed and pressure is increased or reduced according to the traveling direction of the vehicle, the tilting condition of the vehicle body and traveling speed until the crawler belt is brought into an adequate tightened or slackened condition.

5. The track adjuster according to claim 1, wherein the control means performs control such that when the vehicle makes a turn during traveling, the working pressure of the hydraulic actuator of the track adjuster for a base carrier which is moving in a forward direction is maintained at a proper value for forward drive, whereas the working pressure of the hydraulic actuator of the track adjuster for a base carrier which is moving in a backward direction is maintained at a proper value for reverse drive.

6. The track adjuster according to claim 1, wherein the operating condition detecting means is a hydraulic sensor for detecting the pressure of the hydraulic actuator.

7. The track adjuster according to claim 1, wherein the hydraulic pump is operated so as to maintain the pressure of the discharge side of the hydraulic circuit during periods of time except the driving time when the hydraulic actuator is in operation.

8. The track adjuster according to claim 1, further comprising means for detecting the advancement/withdrawal position of a moving part of the hydraulic actuator.

9. The track adjuster according to any one of claims 1 to 8, wherein the hydraulic actuator, hydraulic pump, direction selector valve and operating condition detecting means are independently provided for each of the right and left base carriers.

10. The track adjuster according to any one of claims 1 to 8, wherein the hydraulic actuator is supplied with pressure oil from a hydraulic source located in the vehicle body through the direction selector valve.
